(19) United States
(12) Patent Application Publication
(10) Pub. No.: US 2014/0012474 A1
(43) Pub. Date: Jan. 9, 2014

(54) METHOD FOR CONTROLLING AN ELECTROMECHANICAL CLUTCH SYSTEM IN A MOTOR VEHICLE

(71) Applicant: GM GLOBAL TECHNOLOGY OPERATIONS LLC, Detroit, MI (US)

(72) Inventors: Christian Ruebsam, Bodenheim (DE); Michael Selinger, Mainz (DE)

(21) Appl. No.: 13/935,145

(22) Filed: Jul. 3, 2013

(30) Foreign Application Priority Data
Jul. 7, 2012 (DE) 102012013604.8

(51) Int. Cl. F16D 27/14

(52) U.S. Cl. CPC F16D 27/14
USPC 701/68

(57) ABSTRACT

A method is provided for controlling an electromechanical clutch system in a motor vehicle. The motor vehicle includes, but is not limited to a clutch and a clutch pedal uncoupled mechanically from the clutch. The system is configured to determine a gear input rotation speed (nG), determine a pedal travel (w) covered by the clutch pedal, compare a maximum rotation speed (nmax) of the engine with the gear input rotation speed (nG), actuate the clutch independently of the pedal travel (w), when the gear input rotation speed (nG) is greater than the maximum rotation speed (nmax) of the engine, and the pedal travel (w) is so small that an actuation of the clutch (12) dependent on the pedal travel (w) would lead to an exceeding of the maximum rotation speed (nmax).

### CROSS-REFERENCE TO RELATED APPLICATION

This application claims priority to German Patent Application No. 10 2012 013 604.8, filed Jul. 7, 2012, which is incorporated herein by reference in its entirety.

### TECHNICAL FIELD

The technical field relates to a method for controlling an electromechanical clutch system in a motor vehicle that has a clutch and a clutch pedal uncoupled mechanically from the clutch.

### BACKGROUND

In an electromechanical clutch system (clutch by wire) no direct mechanical connection exists between the clutch pedal and the clutch. Rather, a clutch pedal position is delivered electronically to a control system, which acts on the clutch via an actuator. The actual actuation of the clutch therefore takes place ultimately via a force which is generated in the actuator and not on the clutch pedal. The actuator can have here, for example, electromotive, hydraulic or pneumatic components.

From DE 102 16 548 A1 a vehicle with over-revving protection has become known, in which the engaging is controlled as a function of the engine rotation speed. The clutch opens or slips in the case where the engine rotation speed on engaging exceeds a presettable limit value. An engine rotation speed is used as limit value which is produced from the instantaneous vehicle speed and the instantaneous or aimed-for gear ratio. Faulty operations and an over-revving of the engine connected therewith are thereby prevented more reliably than hitherto.

At least one problem exists in indicating a method for controlling an electromechanical clutch with a clutch pedal that is uncoupled mechanically from the clutch, which prevents an exceeding of the maximum permissible rotation speed of the engine or respectively the maximum rotation speed on a faulty actuation of the clutch.

### SUMMARY

Accordingly, a method is provided for controlling an electromechanical clutch system in a motor vehicle. The motor vehicle has a clutch and a clutch pedal uncoupled mechanically from the clutch, with the steps of determining a gear input rotation speed (nG), determining a pedal travel (w) covered by the clutch pedal (12), actuating the clutch (2) independently of the pedal travel (w), when a) the gear input rotation speed (nG) is greater than the maximum rotation speed (nmax) of the engine, and b) the pedal travel (w) is so small that an actuation of the clutch (12) dependent on the pedal travel (w) would lead to an exceeding of the maximum rotation speed (nmax).

The pedal travel (w) that is covered here is that which is carried out by the driver by foot actuation. It can be vary, starting from a completely released or respectively not pressed clutch pedal with engaged clutch with w=0% up to the completely depressed clutch pedal with disengaged clutch with w=100%. The maximum rotation speed is a specific rotation speed value for the respective engine, which can be deposited electronically, for example in a permanent memory as in a flash memory, which is associated with the engine control unit.

The actuation of the clutch, independent of the pedal travel, mentioned in the last but one paragraph, is the electromechanical clutch actuation, or respectively the clutch actuation independent of the driver, in contrast to the conventional approach of a clutch actuation, which according to a pedal field characteristic depends on the pedal travel which is covered.

Through the above method, it can be prevented that the engine, on engaging after a faulty downshift or respectively on a faulty actuation of the clutch pedal, rotates in a rotation speed range which would involve an increased wear or respectively an overloading of the components.

In an embodiment of the method, the clutch is operated in a slipping manner until the gear input rotation speed has fallen to such an extent that it coincides with the maximum rotation speed or respectively no longer exceeds the latter. Thereby, the engine can be used for the deceleration of the vehicle (engine brake), without turning the engine beyond its maximum rotation speed. On reaching the maximum rotation speed, the clutch can be closed completely or respectively the travel signal of the clutch pedal can be passed on again electronically to the clutch in a manner provided for the respective clutch system.

In an embodiment, the gear input rotation speed is determined from a wheel rotation speed, a transmission ratio of the drive train and a gear which is engaged. A transmission ratio between the gear input rotation speed and a gear output rotation speed is associated with each gear. The gear input rotation speed can be calculated from a known transmission ratio of the drive train and a gear which has just been engaged from a wheel rotation speed or respectively a vehicle speed and a dynamic wheel diameter. In an alternative or additional embodiment, the gear input rotation speed is determined via a rotation speed sensor arranged on the gear unit.

According to an embodiment, the clutch is engaged as a function of the pedal travel, when the clutch pedal is actuated independently by the driver at a biting point at which the engine rotation speed remains less than or equal to the maximum rotation speed. This means that the method for preventing an exceeding of the maximum rotation speed only becomes active when the driver releases the clutch pedal too quickly. With correct actuation of the clutch pedal, the driver therefore does not notice that his vehicle automatically prevents the maximum rotation speed by the method according to Claim 1.

In an embodiment, provision can be made to calculate an application of energy introduced into the clutch during the actuation of the clutch, and to open the clutch starting from a predetermined application of energy. The application of energy is a measurement for the frictional heat introduced into the clutch. The temperature of the clutch can be inferred from known heat dissipation characteristics. In order to protect the clutch from a heating to undesired temperatures, it can be opened according to the manner described in the preceding section.

The clutch system can be provided in a motor vehicle with a control unit, wherein the control unit has a storage means with a computer program deposited thereon, wherein the computer program can be configured for carrying out the method according to embodiments. The control unit can have a digital microprocessor unit (CPU) data-connected with a memory system and a bus system, a random access memory (RAM) and a storage means. The CPU is constructed to process commands which are carried out as a program deposited in a memory system, to detect input signals from the data bus and to deliver output signals to the data bus. The memory system can have various storage media such as optical, magnetic, solid state and other non-volatile media, on which a corresponding computer program is stored for carrying out the method and the advantageous embodiments. The program can be provided such that it embodies the methods described here or respectively is able to carry them out, so that the CPU can carry out the steps and hence can control the clutch system.

A computer program is suitable for carrying out a method which has program product, in order to carry out all the steps of any desired one of the claims, when the program is executed on a computer. The computer program can be read into already existing control units by simple means and used in order to control an electromechanical clutch system. A computer program product is provided for this with program code means which are stored on a machine-readable data carrier, in order to carry out the method according to any desired one of the claims when the program product is executed on a computer. The computer program product can also be integrated as an add-on option in a control unit.

A further embodiment relates to an apparatus for controlling an electromechanical clutch system in a motor vehicle. The motor vehicle has a clutch and a clutch pedal uncoupled mechanically from the clutch. The apparatus has: a device for determining a gear input rotation speed, a device for determining a pedal travel covered by the clutch pedal, a device for actuating the clutch independently of a pedal travel of the clutch pedal when a) the gear input rotation speed nG is greater than the maximum rotation speed nmax of the engine, and b) the pedal travel w is so small that an actuation of the clutch dependent on the pedal travel w would lead to an exceeding of the maximum rotation speed nmax.

In an embodiment of the apparatus, the actuating devices are constructed to operate the clutch in a slipping manner until the gear input rotation speed has fallen to such an extent that it coincides with the maximum rotation speed of the engine or respectively no longer exceeds the latter. Furthermore, in the apparatus the actuating apparatus can be constructed to engage the clutch as a function of the pedal travel w, when the clutch pedal is actuated independently by the driver at a biting point at which the engine rotation speed nMot remains less than or equal to the maximum rotation speed.

In a further embodiment of the apparatus, a device is provided that determine the gear input rotation speed from a wheel rotation speed, a transmission ratio of the drive train and an engaged gear.

In an embodiment of the apparatus in addition devices are provided by which, during the actuation of the clutch, an application of energy that is introduced into the clutch is calculated and the clutch is opened starting from a predetermined application of energy.

### BRIEF DESCRIPTION OF THE DRAWINGS

The present invention will hereinafter be described in conjunction with the following drawing figures, wherein like numerals denote like elements, and:

FIG. 1 is diagrammatically a clutch system of a motor vehicle; and

FIG. 2 is diagrammatically a process flow for controlling the clutch system.

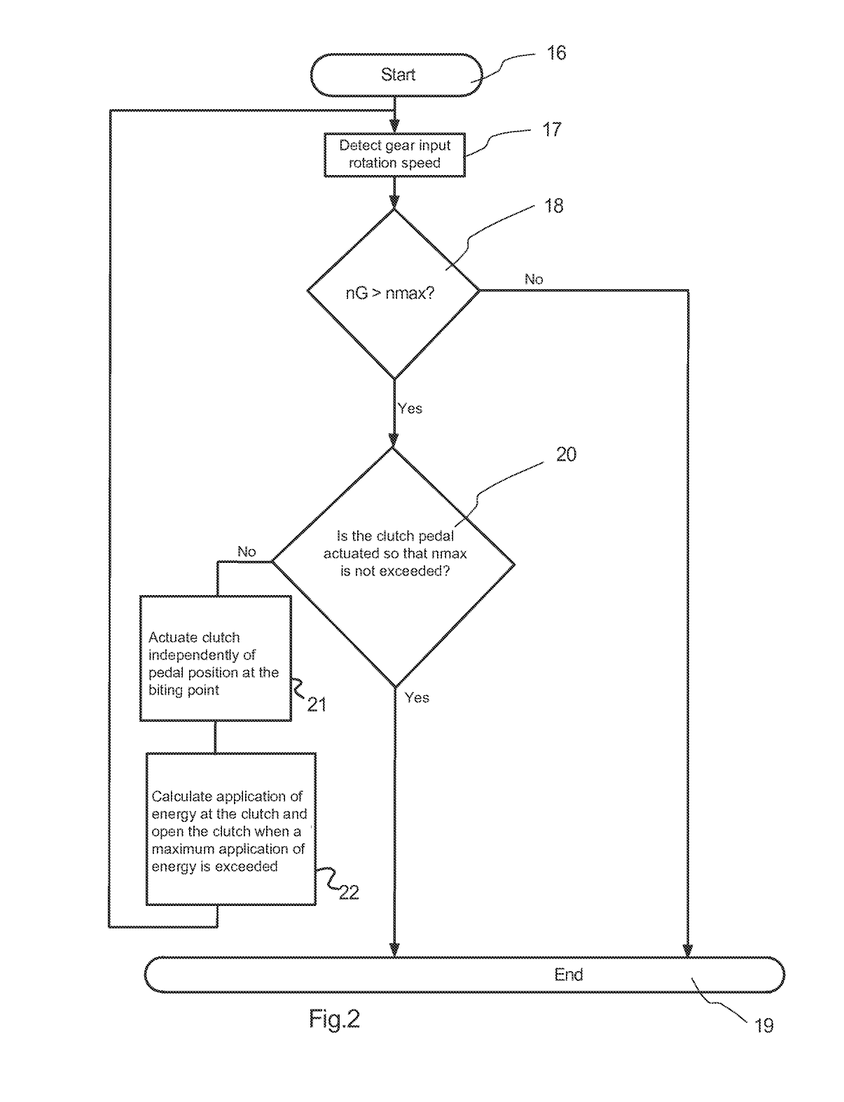

### DETAILED DESCRIPTION

The following detailed description is merely exemplary in nature and is not intended to limit application and uses. Furthermore, there is no intention to be bound by any theory presented in the preceding background or summary or the following detailed description.

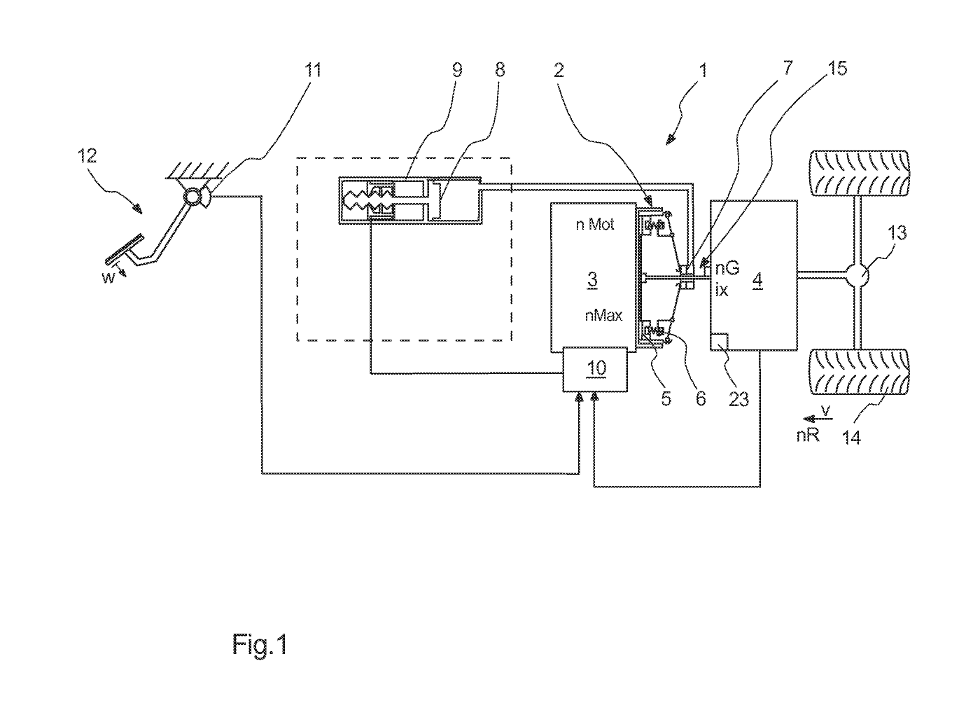

FIG. 1 shows diagrammatically a clutch system 1 with a clutch 2 that is configured to connect an engine 3 with a gear unit 4 by friction fit. For this, the clutch 2 has friction pads 5, which are brought into friction fit with one another with a closed or respectively connected clutch 2 via springs 6. To open the clutch 2, the friction pads 5 or respectively the springs 6 can be relieved by a cylinder 7. The cylinder 7 is in fluid connection with a piston 8 which can be displaced linearly via an actuator 9. Hereby, a fluid pressure can be built up, which moves the cylinder 7. The actuator 9 is controlled by a control unit 10 which is connected in a data-transmitting manner with a path sensor 11. The path sensor 11 is provided on a clutch pedal 12. The path sensor 11 is equipped to detect a travel w covered on the clutch pedal. Depending on the position of the clutch pedal 12, thereby the clutch 2 can be controlled without a direct mechanical connection between the clutch pedal 12 and the clutch 2. The clutch pedal 12 has a spring, which is not illustrated, which presses the clutch pedal 12 back into its position illustrated in FIG. 1 (pedal travel w=0), when the pedal is released.

The clutch system 1 can be provided in an otherwise not illustrated motor vehicle, in which an output of the gear unit 4 is connected in a torque-transmitting manner with wheels 14 via a differential 13, so that the engine 3 can drive the motor vehicle via the clutch 3 or respectively the gear unit 4.

The gear unit 4 can be operated in various gears. A transmission ratio ix is associated with each gear. The differential 13 has a constant transmission ratio iDiff. A vehicle speed v can be determined from a wheel rotation speed nR. In the case of an engaged gear in the gear unit 4, in addition a gear input rotation speed nG can be determined from the transmission ratio ix associated with the gear. The gear can be determined for example via a gear detection sensor 23. Alternatively or additionally, the gear input rotation speed nG can also be determined via a rotation speed sensor 15 arranged on the gear unit 4.

The engine 3 can be operated with a variable engine rotation speed nMot. The clutch 2 is configured, through friction fit on the friction surfaces, to adapt the gear input rotation speed nG constantly up to the fully connected state. For this, the clutch 2 can be held at a biting point until the gear input rotation speed nG is equal to the engine rotation speed nMot. The holding of the clutch 2 at the biting point can be controlled or respectively regulated by the control unit 10. Controlling can be carried out on the basis of a characteristic map, which has as input parameter for example the gear input rotation speed nG and/or the engine rotation speed nMot and actuates the clutch 2 with the aid of empirically determined or calculated parameters via the actuator 9. Furthermore, a control can be implemented electronically in the control apparatus 10 with a P-controller, a PI-controller, a PID-controller or suchlike. A control can have for example as setpoint value the maximum engine rotation speed nMot and can correspondingly control the clutch 2 (at the biting point) until the gear input rotation speed nG is less than or equal to the maximum engine rotation speed nMax. The control can also take place in a separate component from the control apparatus 10.

In towing operation, the vehicle is already travelling at a speed v, so that the engine 3 can be driven by the drive train (formed substantially of gear unit 4 and differential 13) with a closed clutch 2 from the exterior. In so doing, to protect in particular the mechanical components in the engine 3 which are not illustrated here, a permissible maximum rotation speed nmax should not be exceeded. If the driver selects a low gear ix at high vehicle speeds v, then the gear input rotation speed nG can under certain circumstances be higher than the maximum rotation speed nmax. The engaging of a low gear ix can be initiated intentionally by the driver for example when travelling downhill, in order to operate the engine 3 as a brake (engine brake). The engine 3 then runs in towing operation, which can in principle also be carried out over a longer period of time. So that the maximum rotation speed nmax is not exceeded at low gears and increased speeds, provision is made that the clutch 2 is operated at the biting point independently of the pedal actuation until at least the maximum rotation speed nmax is reached on the engine 3. For this, a method described below can be implemented in the control unit 10. The method can run constantly in the control unit 10 or can be started only when, at increased vehicle speeds v, a shift back into a relatively low gear is carried out.

After the start 16, in the manner described above the gear input rotation speed nG can be detected in a step 17. In a query 18 an inquiry can be made as to whether the gear input rotation speed nG is greater than the maximum rotation speed nmax. If the response to this is “no”, then the program can be terminated in a step 18, whereupon it can be started again. If the response to the query 18 is “yes”, then in a next query 20 an inquiry can be made as to whether the clutch pedal 12 is actuated so that the maximum rotation speed nmax is not exceeded also without an intervention. Only in the case of a faulty actuation of the clutch pedal 12, when the travel w would be so small and the torque transmitted via the clutch 2 to the engine 3 would be so great that the maximum rotation speed nmax is exceeded, does the control unit 10 intervene in step 21. The intervention takes place so that the clutch 2 is operated at the biting point independently of the pedal travel w until the gear input rotation speed nG is less than or equal to the maximum rotation speed nmax. The driver is thereby assisted on utilizing the engine brake by engaging a low gear. A loading of the engine 3 beyond the maximum rotation speed nmax is ruled out. In order to prevent an overheating of the clutch 2, in a step 22 an application of energy introduced into the clutch 2 can be determined, and if applicable with an increased application of energy the clutch 2 can be opened, in order to cool it. Subsequently, a corresponding warning signal can be emitted, in order to inform the driver of this procedure. The application of energy can be determined from a period in which the clutch 2 is operated in a slipping manner, and also from a transmitted torque. The torque can be determined empirically for various operating points or respectively can be calculated from given parameters and deposited in a characteristic map. A reserve can be provided, in order to not reach the increased application of energy at all.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A method for controlling an electromechanical clutch system in a motor vehicle, the motor vehicle comprises a clutch and a clutch pedal uncoupled mechanically from the clutch, the method comprising the steps of:
determining a gear input rotation speed;
determining a pedal travel covered by the clutch pedal;
comparing a maximum rotation speed (nmax) of the engine with the gear input rotation speed;
actuating the clutch independently of the pedal travel, when the gear input rotation speed is greater than the maximum rotation speed of the engine, and the pedal travel is so small that an actuation of the clutch dependent on the pedal travel would lead to an exceeding of the maximum rotation speed.

2. The method according to claim 1, wherein the clutch is operated in a slipping manner until the gear input rotation speed has fallen to such an extent to coincides with the maximum rotation speed.

3. The method according to claim 1, wherein the clutch is engaged as a function of the pedal travel, when the clutch pedal is actuated independently by the driver at a biting point at which the engine rotation speed remains less than or equal to the maximum rotation speed.

4. The method according to claim 1, wherein the gear input rotation speed is determined from a wheel rotation speed, a transmission ratio of a differential, and an engaged gear.

5. The method according to claim 1, wherein the gear input rotation speed is detected by a rotation speed sensor arranged on the gear unit.

6. The method according to claim 1, wherein during the actuation of the clutch an application of energy is introduced into the clutch is calculated and the clutch is opened starting from a predetermined application of energy.

7. A motor vehicle, comprising:
an electromechanical clutch system;
a clutch;
a clutch pedal uncoupled mechanically from the clutch; and
a control unit having a storage with a non-transitory computer program product residing in the storage, the non-transitory computer program product is configured to:
determine a gear input rotation speed;
determine a pedal travel covered by the clutch pedal;
compare a maximum rotation speed (nmax) of the engine with the gear input rotation speed;
actuate the clutch independently of the pedal travel, when the gear input rotation speed is greater than the maximum rotation speed of the engine, and the pedal travel is so small that an actuation of the clutch dependent on the pedal travel would lead to an exceeding of the maximum rotation speed.

8. (canceled)

9. (canceled)

10. The motor vehicle according to claim 7, wherein the clutch is operated in a slipping manner until the gear input rotation speed has fallen to such an extent to coincide with the maximum rotation speed.

11. The motor vehicle according to claim 7, wherein the clutch is engaged as a function of the pedal travel, when the clutch pedal is actuated independently by the driver at a biting point at which the engine rotation speed remains less than or equal to the maximum rotation speed.

12. The motor vehicle according to claim 7, wherein the gear input rotation speed is determined from a wheel rotation speed, a transmission ratio of a differential, and an engaged gear.

13. The motor vehicle according to claim 7, wherein the gear input rotation speed is detected by a rotation speed sensor arranged on the gear unit.

14. The motor vehicle according to claim 7, wherein during the actuation of the clutch an application of energy introduced into the clutch is calculated and the clutch is opened starting from a predetermined application of energy.

15. A non-transitory computer readable medium embodying a computer program product, said computer program product comprising:
a control program for a motor vehicle comprising an electromechanical clutch system, a clutch, and a clutch pedal uncoupled mechanically from the clutch, the control program configured to:
determine a gear input rotation speed;
determine a pedal travel covered by the clutch pedal;
compare a maximum rotation speed (nmax) of the engine with the gear input rotation speed;
actuate the clutch independently of the pedal travel, when the gear input rotation speed is greater than the maximum rotation speed of the engine, and the pedal travel is so small that an actuation of the clutch dependent on the pedal travel would lead to an exceeding of the maximum rotation speed.

16. The non-transitory computer readable medium embodying the computer program product according to claim 15, wherein the control program is further configured to operate the clutch in a slipping manner until the gear input rotation speed has fallen to such an extent to coincide with the maximum rotation speed.

17. The non-transitory computer readable medium embodying the computer program product according to claim 15, wherein the control program is further configured to engage the clutch as a function of the pedal travel, when the clutch pedal is actuated independently by the driver at a biting point at which the engine rotation speed remains less than or equal to the maximum rotation speed.

18. The non-transitory computer readable medium embodying the computer program product according to claim 15, wherein the control program is configured to determine the gear input rotation speed from a wheel rotation speed, a transmission ratio of a differential, and an engaged gear.

19. The non-transitory computer readable medium embodying the computer program product according to claim 15, wherein the control program is configured to detect the gear input rotation speed with a rotation speed sensor arranged on the gear unit.

20. The non-transitory computer readable medium embodying the computer program product according to claim 15, wherein during the actuation of the clutch, the control program is further configured to calculate an application of energy introduced into the clutch and further configured to open the clutch starting from a predetermined application of energy.
